(19) United States
(12) Patent Application Publication
(10) Pub. No.: US 2025/0173253 A1
(43) Pub. Date: May 29, 2025

(54) Video Game User Interface Testing System

(71) Applicant: Electronic Arts Inc., Redwood City, CA (US)

(72) Inventors: Alessandro Lentini, Madrid (ES); Ricardo Sulbaran Socas, Madrid (ES); Cristian Castillo de Leon, Madrid (ES); Iago Quintas, Madrid (ES)

(21) Appl. No.: 18/581,164

(22) Filed: Feb. 19, 2024

Related U.S. Application Data
(60) Provisional application No. 63/602,793, filed on Nov. 27, 2023.

(51) Int. Cl. G06F 11/36; A63F 13/533; G06T 7/70; G06V 20/62

(52) U.S. Cl. CPC G06F 11/3698; G06T 7/70; G06V 20/62; A63F 13/533; G06T 2200/24; G06T 2207/20084

(57) ABSTRACT

This specification describes a method for testing a user interface of a video game, the method implemented by one or more processors, the method comprising: obtaining, by one or more of the processors, a screenshot of the video game; processing, by one or more of the processors, the screenshot of the video game to detect one or more user interface elements; and performing, by one or more of the processors, one or more actions in the video game based upon the detected one or more user interface elements for testing the user interface of the video game.

### CROSS-REFERENCE TO RELATED APPLICATION

The present utility application claims the benefit of previously filed U.S. Provisional Application Ser. No. 63/602,793 filed on Nov. 27, 2023, and all contents thereof are incorporated herein by reference.

### BACKGROUND

Testing is an essential part of the video game development process. Testing can include functional testing which tests whether the underlying code is operating correctly. Testing can also include manual testing which may involve a tester manually carrying out actions in a video game following a set of testing instructions. Whilst functional testing can ensure that the underlying functions operate correctly, manual testing of a user interface may be required to ensure that those functions can be accessed and executed in the video game by a player.

### SUMMARY

In accordance with a first aspect, there is provided a method for testing a user interface of a video game, the method implemented by one or more processors, the method comprising: obtaining, by one or more of the processors, a screenshot of the video game; processing, by one or more of the processors, the screenshot of the video game to detect one or more user interface elements; and performing, by one or more of the processors, one or more actions in the video game based upon the detected one or more user interface elements for testing the user interface of the video game.

In accordance with a second aspect, there is provided a system comprising: one or more processors; and one or more computer readable storage media comprising processor readable instructions to cause the one or more processors to carry out a method comprising: obtaining, by one or more of the processors, a screenshot of the video game; processing, by one or more of the processors, the screenshot of the video game to detect one or more user interface elements; and performing, by one or more of the processors, one or more actions in the video game based upon the detected one or more user interface elements for testing the user interface of the video game.

In accordance with a third aspect, there is provided one or more non-transitory computer-readable storage media comprising instructions which, when executed by one or more processors, cause the one or more processors to carry out a method comprising: obtaining, by one or more of the processors, a screenshot of the video game; processing, by one or more of the processors, the screenshot of the video game to detect one or more user interface elements; and performing, by one or more of the processors, one or more actions in the video game based upon the detected one or more user interface elements for testing the user interface of the video game.

### BRIEF DESCRIPTION OF THE DRAWINGS

FIG. 1 is a schematic block diagram illustrating an example of a video game user interface testing system.

FIG. 2 is a flowchart illustrating an example method for testing a user interface of a video game.

FIG. 3 is a flowchart illustrating an example method for processing a screenshot of a video game to detect one or more user interface elements.

FIG. 4A is a schematic illustration of a screenshot of a video game.

FIG. 4B is a schematic illustration of detected icons from the screenshot represented by FIG. 4A.

FIG. 5A is a schematic illustration of another screenshot of a video game.

FIG. 5B is a schematic illustration of detected user interface elements from the screenshot represented by FIG. 5A.

FIG. 6 is a flowchart illustrating an example method for processing a screenshot to identify one or more candidate locations of user interface elements.

FIG. 7A is a schematic illustration of a further screenshot of a video game.

FIG. 7B is a schematic illustration of the output of an edge detection process applied to the screenshot represented by FIG. 7A.

FIG. 7C is a schematic illustration of the output of a contour detection process applied to the edge detection output of FIG. 7B.

FIG. 7D is a schematic illustration of bounding boxes generated from the contour detection output of FIG. 7C.

FIG. 8 shows a schematic illustration of an example of a system/apparatus for performing any of the methods described herein.

### DETAILED DESCRIPTION

### General Definitions

The following terms are defined to aid the present disclosure and not limit the scope thereof.

A “user” or “player”, as used in some embodiments herein, refers to an individual and/or the computing system(s) or device(s) corresponding to (e.g., associated with, operated by) that individual.

A “video game” as used in some embodiments described herein, is a virtual interactive environment in which players engage.

A “screenshot” as used in some embodiment described herein, is a capture of an image frame output by a video game that is displayed on a display device or intended for display on a display device.

The systems and methods described in this specification enable the testing of video game user interfaces without the need to access the internal state of the video game or to specifically run the video game inside a debugging tool to gain additional telemetry data from the video game. The testing system requires only a screenshot of the video game, i.e. the visual output of the video game, and uses various image processing, classification techniques, and machine learning techniques to detect user interface elements from the screenshot. The testing system can then perform actions in the video game to test the user interface of the video game on the basis of the detected user interface elements. The testing system can therefore be applied to any video game and does not require specific modification of the video game itself to be used.

The systems and methods described herein are particularly suitable for testing the initial starting user interface of a video game. Typically, when a video game is launched, a user will be presented with a starting screen that provides options for starting one or more game modes of the video game, for example to start a single player game mode or a multiplayer game mode, or to load a previous saved game state, or to configure various settings of the video game amongst other options. Selecting an option within the starting screen may lead to further screens with additional options for the user to select. The testing system described herein is capable of automatically navigating through a starting screen and subsequent screens of the user interface in order to test the user interface.

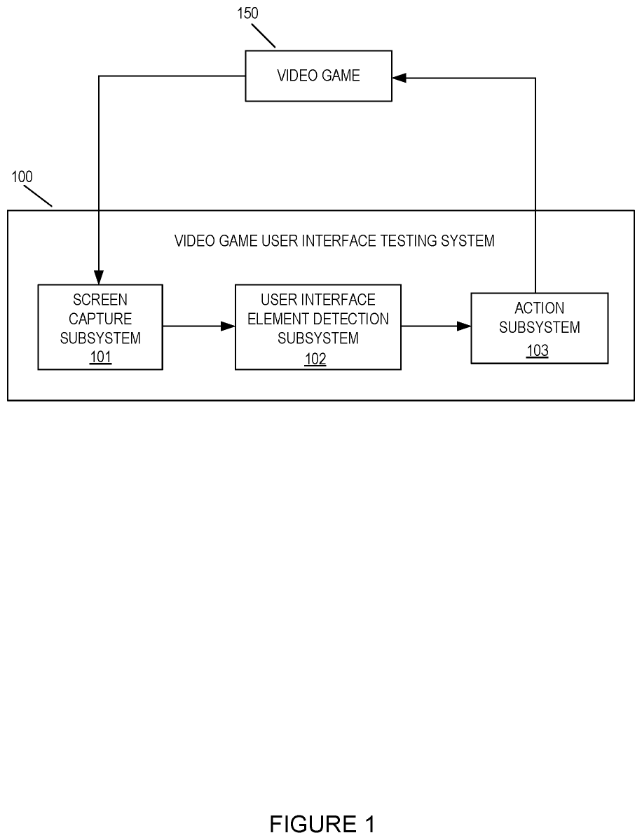

FIG. 1 is a schematic block diagram illustrating an example of a video game user interface testing system 100. The testing system 100 may be implemented by one or more processors located in one or more locations. The testing system 100 may comprise a server, desktop computer, a mobile device such as a laptop, smartphone or tablet, or any other suitable computing apparatus. The testing system 100 may be a distributed system or cloud-based system.

The testing system 100 is configured to interact with a video game 150 in order to test the user interface of the video game 150. For example, a test may involve whether the user interface can be navigated to change the volume or other settings of the video game 150. The testing system 100 and the video game 150 may be operating on the same computing device or the testing system 100 or the video game 150 may be operating on different computing devices and be linked via any suitable network connection. The testing system 100 may be configured to operate the video game 150 as described in more detail below.

The testing system 100 is configured to obtain a screenshot of the video game 150. In some implementations, the testing system 100 comprises a screen capture subsystem 101, as shown in FIG. 1, which is configured to capture a screenshot of the video game 150 whilst the video game is running. In other implementations, the screenshot may be captured by an entity external to the testing system 100. For example, a video game console or PC running the video game 150 may capture a screenshot and transmit the screenshot to the testing system 100. The screenshot may be encoded in any appropriate image file format such as, JPEG or PNG etc.

The testing system 100 is further configured to process the screenshot of the video game 150 to detect one or more user interface elements. This may be carried out by a user interface element detection subsystem 102 of the testing system 100. User interface elements may include menus in various configurations including a bar or grid, buttons, text, and (pictorial) icons. In general, the testing system 100 may be configured to process the screenshot to identify one or more candidate locations of user interface elements, process the screenshot to identify text and/or icons and the corresponding locations of the text and/or icons within the screenshot, and to detect one or more user interface elements based upon the identified candidate locations of user interface elements, the identified text and/or icons, and the identified locations of the text and/or icons. As described in more detail below, the processing may be based upon image processing techniques such as brightness/contrast adjustment, noise/blur filtering, edge detection, and/or contour detection amongst others. In particular, image processing techniques may be used to determine candidate locations of user interface elements. The processing may be based upon one or more machine learning models. For example, various text processing machine learning models may be used such as text detection, text recognition, and/or text classification machine learning models. Icon detection and icon recognition machine learning models may also be used. The machine learning models may be used to determine the type and/or actions associated with a user interface element and to aid in detecting meaningful user interface elements.

The testing system 100 is further configured to perform one or more actions in the video game 150 based upon the detected one or more user interface elements for testing the user interface of the video game 150. This may be carried out by an action subsystem 103 of the testing system 100. As noted above, the testing system 100 is capable of determining the type of each detected user interface element and any actions associated with the user interface element. This enables the testing system 100 to determine the appropriate user interface elements to interact with to carry out the actions necessary for testing the video game user interface. In this regard, the testing system 100 may be configured to obtain an instruction for testing the video game interface and the actions performed in the video game 150 by the testing system 100 attempts to satisfy the instruction. The instruction for testing the video game may be in the form of a test script and may be part of a wider set of instructions. In some implementations, the instruction may be a high-level testing objective which the testing system 100 determines the appropriate actions for execution in the video game to fulfil the testing objective.

The testing system 100 may be configured to select or interact with the detected user interface elements in the video game 150. This may lead to the generation of a new screen in the video game 150, i.e. a change in the visual output of the video game 150, and the testing system 100 may repeat processing on the new screen to detect the user interface elements of the new screen and to determine and perform any further actions.

In some implementations, the testing system 100 is configured to perform actions in the video game 150 to generate a map of the video game user interface. For example, the testing system 100 may systematically select each of the detected user interface elements and any subsequently detected user interface elements on any new screens that are generated so as to “crawl” through the user interface. The map may be used in the determination of actions to perform in the video game or the map may be used to verify the correct implementation of the user interface for example.

The testing system 100 may be configured to perform actions in the video game by emulating gamepad, keyboard and/or mouse inputs or the inputs of any other appropriate input device for the video game 150. The emulated inputs may be transmitted to the video game 150 and the video game 150 may accept and process the emulated inputs as if they were provided by a physical input device controlled by a user.

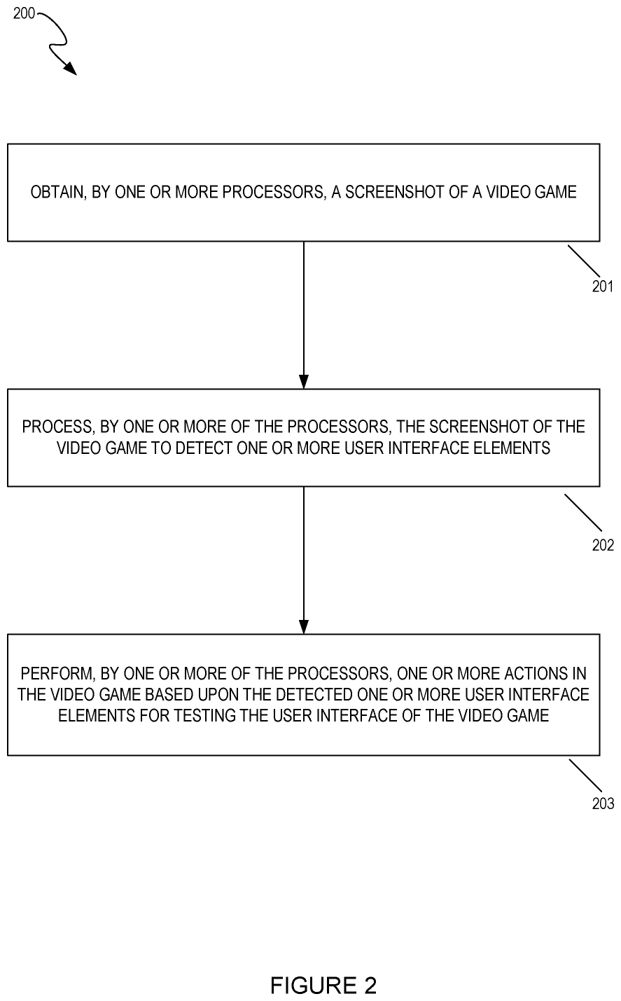

FIG. 2 is a flow diagram illustrating an example method 200 for testing a video game user interface. The processing shown in FIG. 2 may be carried out by the testing system 100 of FIG. 1. The processing shown in FIG. 2 may be implemented by one or more processors in one or more locations.

In step 201, a screenshot of the video game is obtained by one or more processors. As discussed above, the screenshot may be captured by the testing system or the screenshot may be captured by a device or apparatus that the video game is running on and transmitted to the testing system. The screenshot may be encoded in any appropriate image file format.

In step 202, the screenshot of the video game is processed by one or more of the processors to detect one or more user interface elements. As discussed above, the user interface elements may include menus in various configurations including a bar or grid, buttons, text, and icons or other elements. The processing to detect the one or more user interface elements is described in more detail below.

In step 203, one or more actions are performed in the video game by one or more of the processors based upon the detected one or more user interface elements from step 202 for testing the user interface of the video game. As described above, the one or more actions may be to satisfy an instruction for testing the user interface of the video game. For example, the testing instruction may be to navigate the user interface to change a volume setting or other setting of the video game. In another example, the user interface may be “crawled” to generate a map of the user interface for testing purposes, for example to verify the implementation of the user interface.

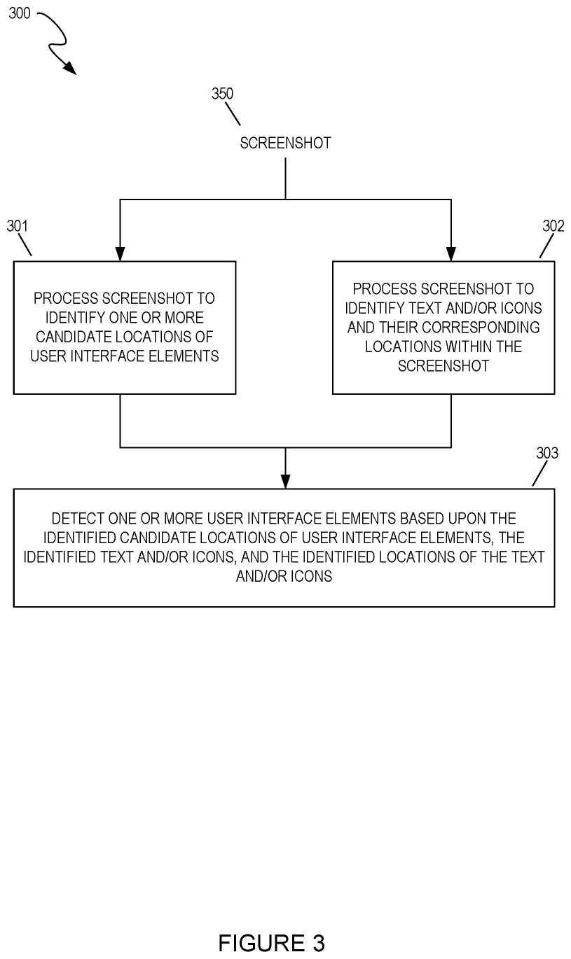

Referring now to FIG. 3, example processing 300 to detect one or more user interface elements from a screenshot of the video game (e.g. step 202 of FIG. 2) will now be described in more detail.

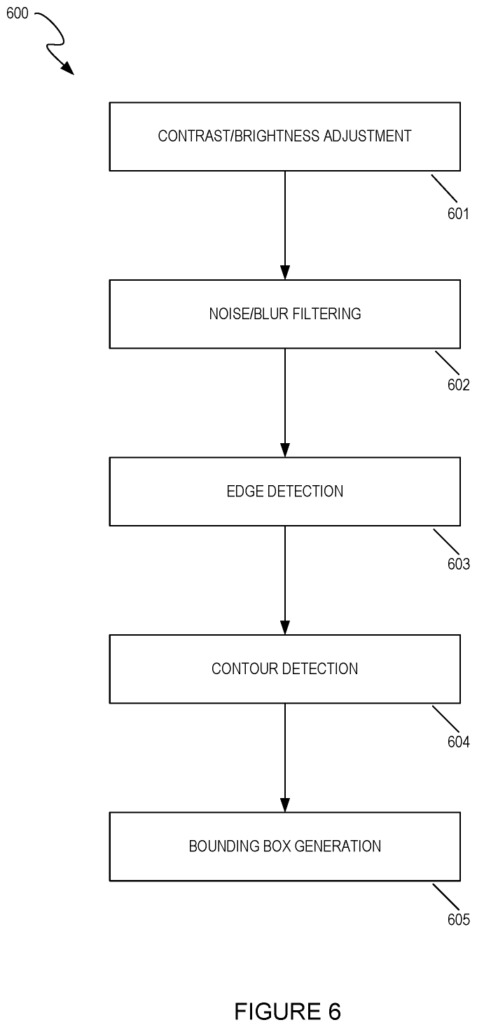

In step 301, a screenshot 350 is processed to identify one or more candidate locations of user interface elements. This processing may be based upon one or more image processing techniques. Further details are provided below with reference to FIG. 6. The candidate locations of user interface elements may be indicated using co-ordinates of bounding boxes. A data structure may be used to store a list of bounding box co-ordinates. The output may be visualized by overlaying the bounding boxes on the screenshot 350 and displayed on an appropriate display device.

In step 302, the screenshot 350 is processed to identify text and/or icons and the corresponding locations of the text and/or icons within the screenshot 350. In some cases, a user interface may comprise text without any icons or may comprise icons without any text. In other cases, a user interface may comprise some combination of text and icons.

In some implementations, the processing to identify text and/or icons and their corresponding locations may be carried out using one or more machine learning models. For example, a text detection machine learning model may be used to process the screenshot 350 to identify locations of text within the screenshot 350. The locations of text may also be indicated using co-ordinates of bounding boxes. A text recognition machine learning model may be used to identify the text within the screenshot, that is to provide a transcription of the text within the screenshot. The text recognition machine learning model may use the output of the text detection machine learning model in its processing, or the text recognition machine learning model may be independent of the text detection machine learning model processing only the obtained screenshot 350. Alternatively, the text detection and text recognition machine learning models may be a joint model.

In some implementations, a data structure, such as a dictionary object, may be used to store a list of the recognized text and their corresponding locations within the screenshot 350. The output may also be visualized by overlaying the bounding boxes and recognized text on the screenshot and displayed on an appropriate display device.

The recognized text may be further processed to classify the text according to a set of labels. For example, the text may be classified according to meaningful terms associated with video game user interface elements such as an associated action. In some implementations, the classification may be carried out based upon a dictionary data structure comprising a mapping from text strings to labels. For example, the text strings: “quit game”, “game menu”, “exit”, “leave game”, “quit”, and “exit to desktop” may all be mapped to the label “exit” to denote that the text is associated with an action to exit the video game. In another example, the text strings: “options”, “settings”, “configuration”, “local configuration”, “game options”, and “player settings” may all be mapped to the label “settings” to denote that the text is associated with an action to open a settings menu of the video game. The recognized text may be compared to the text strings in the dictionary and the most similar text string may be determined. The recognized text may be classified according to the label associated with the most similar text string. The use of a dictionary data structure enables new text strings from new video games to be added and classified without the need to, for example, retrain a text classification machine learning model. On the other hand, a text classification machine learning model may provide a more accurate classification than a comparison of text strings. It will be appreciated that embodiments are not limited to any particular text classification technique and that a person skilled in the art may select a particular technique as deemed necessary. Should a text classification machine learning model be used, the text classification machine learning model may be used in addition to the text detection and/or text recognition machine learning models, or if there is single model, the single model may also carry out text classification. In other implementations, the text classification machine learning model may be used as an alternative to any one of the text processing machine learning models as deemed appropriate by a person skilled in the art.

Identification of icons and their corresponding locations in step 302 may also be carried out using one or more machine learning models. For example, an icon detection machine learning model may be used to process the screenshot 350 to identify the locations of icons within the screenshot 350. The locations may also be indicated using co-ordinates of bounding boxes. An icon classification machine learning model may be used to classify the detected icons according to a set of labels. For example, the set of labels may classify the icons according to a semantic meaning of an icon. The labels may, for example, comprise: “settings”, “accessibility” and/or “controller” to denote that icons are associated with actions for opening a general settings menu, an accessibility settings menu and a controller settings menu respectively.

In some implementations, the icon detection machine learning model and the icon classification machine learning models are separate machine learning models. In other implementations, the icon detection and icon classification machine learning models are a joint machine learning model.

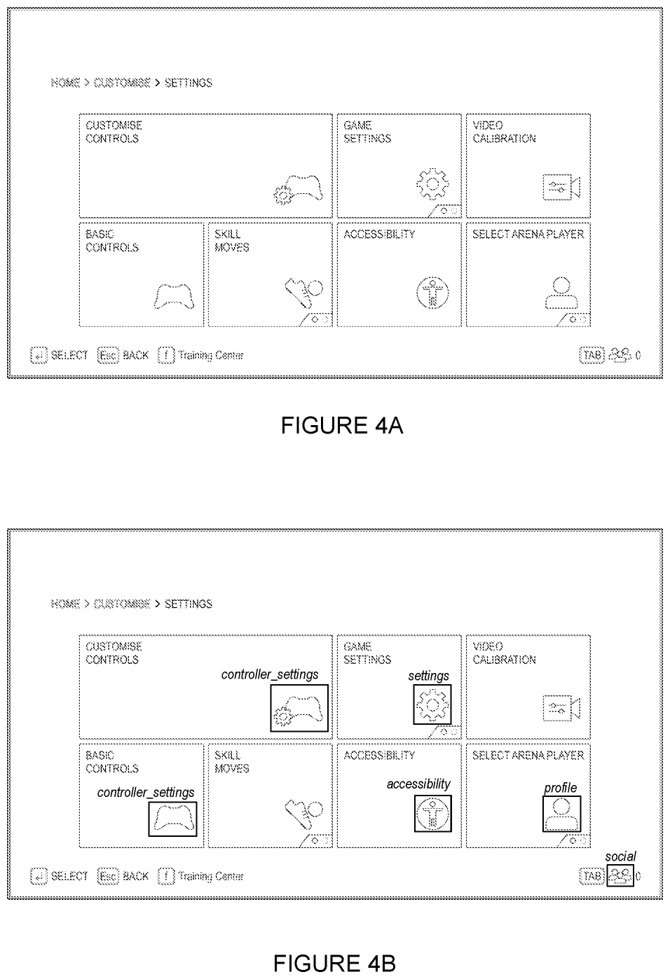

A data structure, such as a dictionary object, may also be used to store a list of the identified icons, e.g. the icon labels, and their corresponding locations within the screenshot 350. The output may also be visualized by overlaying the bounding boxes and icon labels on the screenshot and displayed on an appropriate display device. FIG. 4A shows a schematic illustration of a screenshot of video game. The illustration is of a starting menu in a video game used to launch the video game in a particular game mode or to select options for opening menus to configure particular settings of the video game. FIG. 4B shows the illustration of FIG. 4A overlaid with the bounding boxes of identified icons and example classifications of each.

The above-mentioned machine learning models may take any suitable form for carrying out the particular task as deemed appropriate by a person skilled in the art. In some implementations, a machine learning model comprises a neural network. For example, a convolutional neural network, such as a ResNet-based architecture, may be used in order to process a screenshot to generate an appropriate detection/recognition/classification output. The machine learning models may be trained using any appropriate training method. For example, a neural network may be trained using backpropagation and stochastic gradient descent or any other appropriate optimization technique and training objective for neural networks. The neural network may be trained using supervised learning using an appropriate training dataset comprising a plurality of training examples, each associated with a corresponding “ground-truth” output that the neural network is expected produce. Other forms of learning, such as unsupervised learning, may also be used as deemed appropriate by a person skilled in the art. The testing system 100 of FIG. 1 may further comprise a training subsystem configured to train one or more of the machine learning models. Alternatively, the machine learning models may be trained by a system external to the testing system 100. The machine learning models may be transmitted to the testing system 100 and be stored locally at the testing system 100 or the testing system 100 may access the machine learning models remotely via any appropriate network connection.

Referring back to FIG. 3, as shown, the processing to identify one or more candidate locations of user interface elements in step 301 can be performed in parallel with the processing to identify text and/or icons and their corresponding locations within the screenshot 350 in step 302. Thus, in some implementations, an image processing-based pipeline (step 301) may be used to process the screenshot 350 in parallel with a machine learning-based pipeline (step 302). Alternatively, steps 301 and 302 may be performed serially and in any appropriate order.

In step 303, one or more user interface elements are detected based upon the identified candidate locations of user interface elements, the identified text and/or icons, and the identified locations of the text and/or icons. For example, the outputs of steps 301 and 302 may be combined and used to determine the user interface elements within screenshot 350. In particular, the system may focus on detecting meaningful user interface elements such as elements that can be selected or interacted with or elements that may present information regarding a current game state.

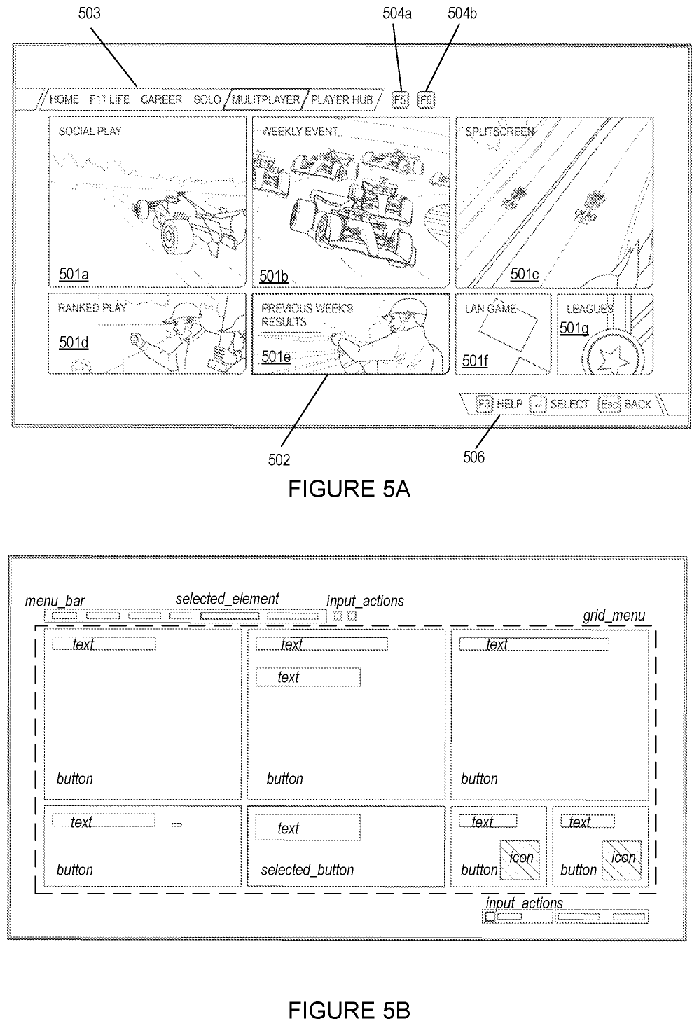

The user interface elements may be detected based upon proximity and/or spatial alignment of the identified candidate locations of user interface elements, the identified text and/or icons and the identified locations of the text and/or icons. For example, a button typically comprises text and/or an icon enclosed within a shape, with the text/icon providing some description/representation of a corresponding action that selecting the button will ensue. Thus, where text and/or an icon is identified and determined to have an appropriate meaning (e.g. an appropriate label), and is located within a bounding box of candidate user interface element, that may be indicative of a button. This is illustrated in FIGS. 5A and 5B. FIG. 5A is a schematic illustration of a screenshot of a launch screen for a “multiplayer” game mode of a video game. Depicted within are seven buttons 501a, 501b, 501c, 501d, 501e, 501f, 501g arranged in a grid. Each button comprises text that indicates a particular multiplayer game mode or associated option that will be launched upon selecting the button. The buttons also comprise illustrative elements that may or may not be relevant for detecting and determining the function of the button. FIG. 5B shows a corresponding identification of user interface elements for the screenshot represented by FIG. 5A. As can be seen, the system has identified the buttons 501a-g of FIG. 5A and the text within.

In another example, detected user interface elements that are in close proximity and that have a particular pattern of spatial alignment may be grouped together into further user interface elements. As discussed above, buttons 501a-g are arranged in a grid. As can be seen in FIG. 5B, the detected buttons have been grouped together as a “grid_menu” user interface element. Typically in a game menu, a particular option will be highlighted as a currently selected option. This is depicted in FIG. 5A by the bold outline 502 around button 501e. The selected button in the grid menu is also detected in FIG. 5B. Further details on the detection of a selected element in a menu is described below.

In a further example, detected text that is in close proximity, is horizontally aligned, has an appropriate classification and is located within an elongated candidate user interface element may be grouped together and identified as options within a menu bar. In FIG. 5A, a menu bar 503 in the top left is identified as such in FIG. 5B. To the right of the menu bar 503, are button prompts 504a and 504b. These button prompts indicate the input keys to press to change the selected option in the menu bar 503. These button prompts are also identified in FIG. 5B as “input_actions”. In the bottom right of FIG. 5A, there is a further group of input actions 506 and these have also been detected in FIG. 5B. The system has correctly differentiated this group from what could be perceived to be a menu bar.

As discussed above, various rules and heuristics based upon the proximity and spatial alignment of detected locations of candidate user interface elements, the identified/classification of text and/or icons and their corresponding locations may be used to determine meaningful user interface elements depicted within a screenshot of a video game. It will be appreciated however that embodiments are not limited to the above discussed examples and that the skilled person may determine user interface elements in any appropriate way.

The rules and heuristics may also be used to determine user interface elements that were not initially identified. For example, if the system identifies a grid menu or menu bar having a spatial gap that would correspond to the size of a menu item, the system may determine that a menu item should be present. The system may then interact with the video game, e.g. by cycling through the items of the grid menu, to confirm whether or not a menu item is indeed present. The system may also interact with the video game to verify that user interface elements have been detected correctly as expected.

A data structure may be used to store a list of the detected user interface elements and their corresponding locations and relationships. The data structure may be used by the testing system to then interact with the video game and to test the user interface of the video game as described above.

Referring now to FIG. 6, example processing 600 to identify one or more candidate locations of user interface elements (e.g. step 301 of FIG. 3) will now be described in more detail. In general, the processing 600 uses a variety of specific image processing techniques. It will be appreciated embodiments are not limited to the specific techniques and order described and that alternative techniques may be used and/or in a different order as deemed appropriate by a person skilled in the art.

In step 601, a contrast/brightness adjustment of the screenshot is performed. The adjustment may be based upon the tonal contrast of the screenshot, that is, the difference in brightness of the brightest and darkest areas of the screenshot. For example, the screenshot in an RGBA color space may be first converted to grayscale and then converted to black and white by applying a threshold. An average tonal contrast may be computed from the black and white image based upon the number of black and white pixels. The contrast and/or brightness of each pixel in the original screenshot may then be adjusted based upon the average tonal contrast value. This dynamic contrast/brightness adjustment can result in an improved contrast between user interface elements and the background to enable better edge and contour detection in the latter stages of processing described below.

In step 602, a noise/blur filtering of the adjusted screenshot from step 601 is performed. Typically, a user interface screen may comprise images for aesthetic purposes, such as background images, that are irrelevant for detecting user interface elements. A filter may be applied to de-emphasise such images. The choice of filter may be selected based upon a contrast and/or sharpness of the adjusted screenshot from step 601. For example, a Gaussian filter may be used in high contrast cases, a median filter may be used in low contrast and low sharpness cases, and a bilateral filter may be used in low contrast and high sharpness cases. It will be appreciated that other filters may be used as deemed appropriate by a person skilled in the art.

The contrast value used for selecting a filter may be computed based upon a histogram representing the distribution of pixel intensities of the adjusted screenshot. The histogram may be computed based upon a grayscale version of the adjusted screenshot. The histogram values may also be normalized. The contrast value may be computed based upon the standard deviation of the histogram values.

The sharpness value used for selecting a filter may be based upon derivatives computed from the adjusted screenshot. For example, a Sobel or Laplacian operator may be used to compute a second derivative to determine a variance indicating a sharpness of the adjusted screenshot.

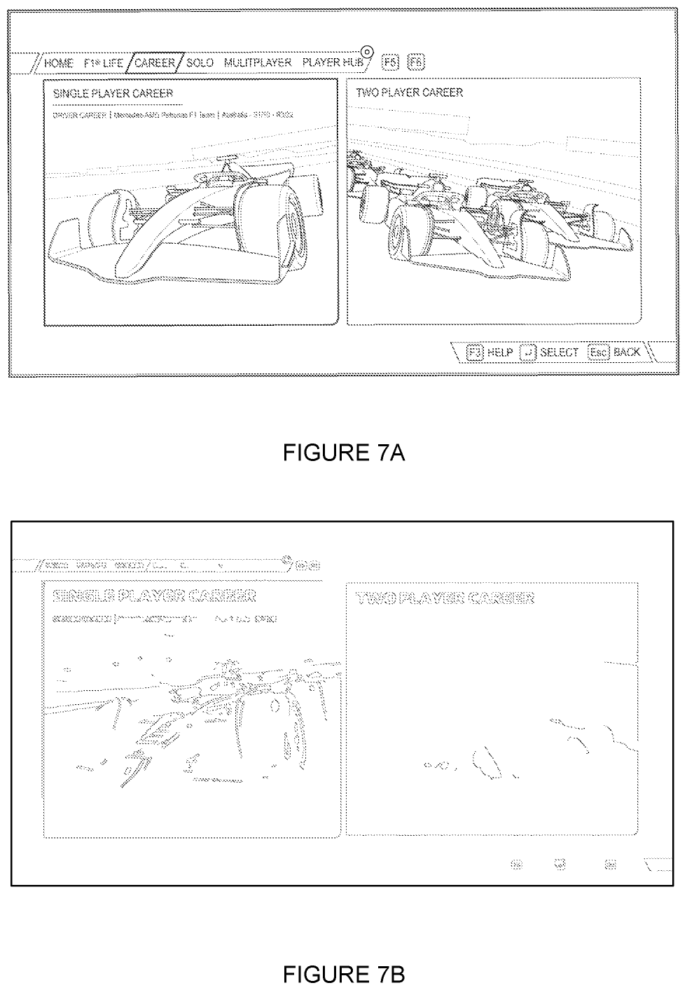

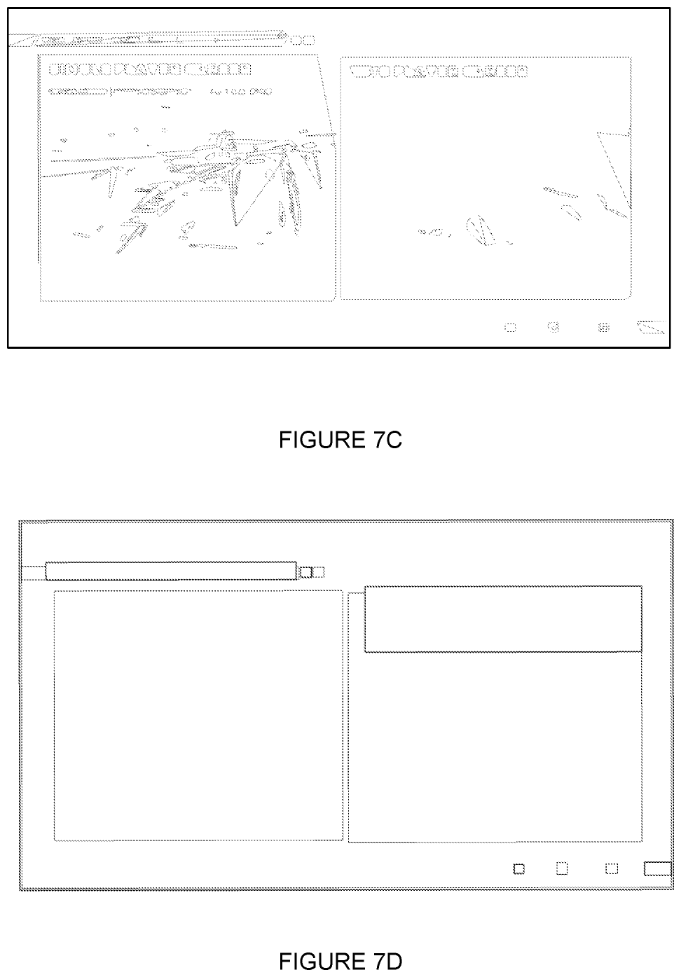

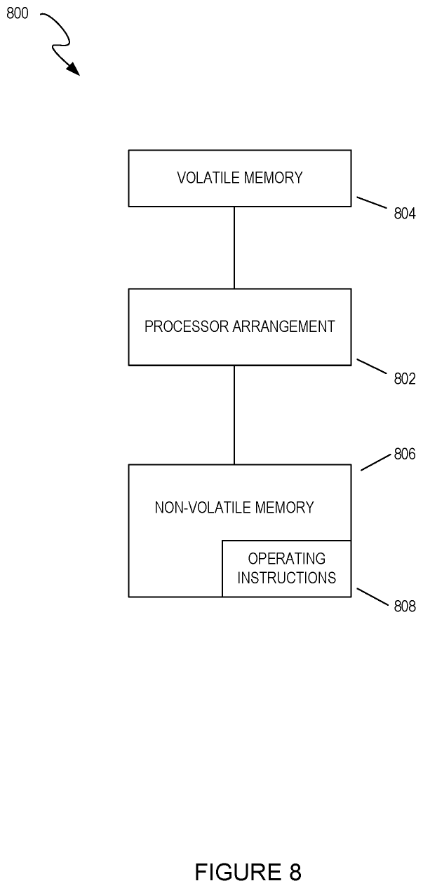

In step 603, edge detection is performed on the filtered screenshot from step 602. Edge detection can help to locate elements such as buttons or menu bars for example. The previous steps for adjusting and filtering the screenshot enables easier detection of edges corresponding to user interface elements. In some implementations, the Canny edge detection algorithm is used. For example, the algorithm may be implemented using median pixel values which may aid in the algorithm's adaptability to different screenshots. However, it will be appreciated that other edge detection algorithms, such as the Sobel operator, may be used as deemed appropriate by a person skilled in the art. FIG. 7A shows a schematic illustration of a screenshot of a launch screen for a “career” game mode of a video game. FIG. 7B shows an example of edge detection output for the screenshot that is represented by FIG. 7A.

Referring back to FIG. 6, in step 604, contour detection is performed based upon the edge detection output from step 603. Contour detection may be considered the process of determining continuous points along a boundary having the same color or intensity. Contour detection may be carried out using any suitable algorithm as deemed appropriate by a person skilled in the art. FIG. 7C shows an example of contour detection output resulting from applying contour detection to the edge detection output from FIG. 7B.

In step 605, bounding boxes are generated from the output of the contour detection from step 604. For example, the contours may be simplified and filtered to keep only those that are closed and convex. Bounding boxes may then be generated to indicate the potential locations of user interface elements. FIG. 7D shows an example of the bounding boxes generated from the contour detection output from FIG. 7C.

Identification of a selected element/option in a menu discussed above with reference to FIG. 3 will now be described in further detail. Typically, a selected element in a menu will be highlighted through a different contrast level or through a different color. In one example, a histogram of each element is generated. A histogram may be generated using any of the techniques described above. The histograms of each element may then be compared. A selected element may be identified based upon the histogram intersection. That is, non-selected elements being of the same general color or contrast will have a higher histogram intersection than with the selected element which will be of a different color or contrast.

FIG. 8 shows a schematic illustration of an example of a system/apparatus 800 for performing any of the methods described herein. The system/apparatus shown is an example of a computing device. It will be appreciated by a person skilled in the art that other types of computing devices/systems may alternatively be used to implement the methods described herein, such as a distributed computing system.

The apparatus (or system) 800 comprises one or more processors 802. The one or more processors control operation of other components of the system/apparatus 800. The one or more processors 802 may, for example, comprise a general purpose processor. The one or more processors 802 may be a single core device or a multiple core device. The one or more processors 802 may comprise a central processing unit (CPU) or a graphical processing unit (GPU). Alternatively, the one or more processors 802 may comprise specialised processing hardware, for instance a RISC processor or programmable hardware with embedded firmware. Multiple processors may be included.

The system/apparatus comprises a working or volatile memory 804. The one or more processors may access the volatile memory 804 in order to process data and may control the storage of data in memory. The volatile memory 804 may comprise RAM of any type, for example Static RAM (SRAM), Dynamic RAM (DRAM), or it may comprise Flash memory, such as an SD-Card.

The system/apparatus comprises a non-volatile memory 806. The non-volatile memory 806 stores a set of operation instructions 808 for controlling the operation of the processors 802 in the form of computer readable instructions. The non-volatile memory 806 may be a memory of any kind such as a Read Only Memory (ROM), a Flash memory or a magnetic drive memory.

The one or more processors 802 are configured to execute operating instructions 808 to cause the system/apparatus to perform any of the methods described herein. The operating instructions 808 may comprise code (i.e. drivers) relating to the hardware components of the system/apparatus 800, as well as code relating to the basic operation of the system/apparatus 800. Generally speaking, the one or more processors 802 execute one or more instructions of the operating instructions 808, which are stored permanently or semi-permanently in the non-volatile memory 806, using the volatile memory 804 to temporarily store data generated during execution of said operating instructions 808.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 6, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

1. A method for testing a user interface of a video game, the method implemented by one or more processors, the method comprising:
obtaining, by one or more of the processors, a screenshot of the video game;
processing, by one or more of the processors, the screenshot of the video game to detect one or more user interface elements; and
performing, by one or more of the processors, one or more actions in the video game based upon the detected one or more user interface elements for testing the user interface of the video game.

2. The method of claim 1, further comprising:
obtaining, by one or more of the processors, an instruction for testing the video game interface; and wherein the one or more actions are based upon the instruction for testing the video game.

3. The method of claim 1, wherein processing, by one or more of the processors, the screenshot of the video game to detect one or more user interface elements comprises:
processing, by one or more of the processors, the screenshot to identify one or more candidate locations of user interface elements;
processing, by one or more of the processors, the screenshot to identify text and/or icons and the corresponding locations of the text and/or icons within the screenshot; and
detecting, by one or more of the processors, one or more user interface elements based upon the identified candidate locations of user interface elements, the identified text and/or icons, and the identified locations of the text and/or icons.

4. The method of claim 3, wherein processing, by one or more of the processors, the screenshot to identify one or more candidate locations of user interface elements is based upon one or more image processing techniques.

5. The method of claim 4, wherein the one or more image processing techniques comprises at least one of the following: a contrast/brightness adjustment, a noise/blur filtering, edge detection, or contour detection.

6. The method of claim 3, wherein processing, by one or more of the processors, the screenshot to identify text and/or icons and the corresponding locations of the text and/or icons within the screenshot is based upon one or more machine learning models.

7. The method of claim 6, wherein the one or more machine learning models comprises at least one of: a text detection machine learning model, a text recognition machine learning model, an icon detection machine learning model, or an icon recognition machine learning model.

8. The method of claim 3, wherein identifying the text and/or icons further comprises:
classifying the text and/or icons.

9. The method of claim 8, wherein classifying the text is based upon a dictionary data structure comprising a mapping from text strings to labels.

10. The method of claim 3, wherein a location is represented by co-ordinates of a bounding box.

11. The method of claim 1, wherein detecting, by one or more of the processors, one or more user interface elements based upon the identified candidate locations of user interface elements, the identified text and/or icons, and the identified locations of the text and/or icons is based upon a proximity and/or a spatial alignment.

12. The method of claim 11, further comprising:
grouping, by one or more of the processors, the detected user interface elements based upon proximity and/or spatial alignment into further user interface elements.

13. The method of claim 1, further comprising:
identifying, by one or more of the processors, a currently selected user interface element from the detected one or more user interface elements.

14. The method of claim 1, wherein the one or more user interface elements comprises at least one of: a menu item, a menu bar, a grid menu, a button, or a button prompt.

15. The method of claim 1, performing, by one or more of the processors, one or more actions in the video game based upon the detected one or more user interface elements for testing the user interface of the video game comprises:
generating a map of the video game user interface by interacting with the detected one or more user interface elements.

16. A system comprising:
one or more processors; and
one or more computer readable storage media comprising processor readable instructions to cause the one or more processors to carry out a method comprising:
obtaining, by one or more of the processors, a screenshot of a video game;
processing, by one or more of the processors, the screenshot of the video game to detect one or more user interface elements; and
performing, by one or more of the processors, one or more actions in the video game based upon the detected one or more user interface elements for testing the user interface of the video game.

17. The system of claim 16, wherein the method further comprises:
obtaining, by one or more of the processors, an instruction for testing the video game interface; and wherein the one or more actions are based upon the instruction for testing the video game.

18. The system of claim 16, wherein the method further comprises:
processing, by one or more of the processors, the screenshot to identify one or more candidate locations of user interface elements;
processing, by one or more of the processors, the screenshot to identify text and/or icons and the corresponding locations of the text and/or icons within the screenshot; and
detecting, by one or more of the processors, one or more user interface elements based upon the identified candidate locations of user interface elements, the identified text and/or icons, and the identified locations of the text and/or icons.

19. One or more non-transitory computer-readable storage media comprising instructions which, when executed by one or more processors, cause the one or more processors to carry out a method comprising:
obtaining, by one or more of the processors, a screenshot of a video game;
processing, by one or more of the processors, the screenshot of the video game to detect one or more user interface elements; and
performing, by one or more of the processors, one or more actions in the video game based upon the detected one or more user interface elements for testing the user interface of the video game.

20. The non-transitory computer-readable storage media of claim 19, wherein the method further comprises:
obtaining, by one or more of the processors, an instruction for testing the video game interface; and wherein the one or more actions are based upon the instruction for testing the video game.
